(19) United States
(12) Patent Application Publication
(10) Pub. No.: US 2007/0278054 A1
(43) Pub. Date: Dec. 6, 2007

(54) Yarn brake with settable braking force

(76) Inventors: Rolf Huss, Lossburg (DE); Atilla Horvath, Freudenstadt (DE); Alfred Lampprecht, Betzweiler-Walde (DE); Friedrich Weber, Herzogsweiler (DE); Patrick Rothfuss, Baiersbronn (DE)

Correspondence Address: RONALD S. LOMBARD;PATENTS AND TRADEMARKS, 4430 TWIN OAKS DRIVE, MURRYSVILLE, PA, 15668, US

(21) Appl. No.: 11/820,074

(22) Filed: Jun. 18, 2007

Related U.S. Application Data
(63) Continuation-in-part of application No. PCT/EP04/14678, filed on Dec. 23, 2004.

(51) Int. Cl. B60L 7/00

(52) U.S. Cl. 188/161

(57) ABSTRACT

The yarn brake (1) according to the invention comprises individually adjustable biasing means (21, 22) which cooperate with plates (8, 9). By adjusting both biasing means (21, 22), desired positions of the brake plates (8, 9) may be deliberately set in a manner other than in conventional yarn brakes. For example, a desired centered position may be preserved for any yarn tension. It is also feasible to shift the desired centered position on purpose by deliberately adjusting both biasing means. The setting of the yarn tension is thus independent from the setting of the centered position.

### CROSS-REFERENCE TO RELATED APPLICATION

This is a continuation-in-part application of international application PCT/EP2004/014678 filed Dec. 23, 2004, and claiming the priority of said international application PCT/EP2004/014678.

### BACKGROUND OF THE INVENTION

Yarn brakes in the form of so-called disc brakes or plate brakes have been widely available. For example, German publication DE 44 09 450 C2 discloses such a yarn brake including two brake plates, each having an annular shape. Two pins serve for movably supporting the brake plates. The pins are held parallel-spaced from one another and support the brake plates at the outer periphery of the latter. A further pin extends through the central opening of the two brake plates. Each brake plate is provided with an annular permanent magnet, so that the two brake plates attract one another and thus clamp a yarn running through there between. To the supporting pins a vibratory motion is imparted which is oriented transversely to the brake plates for continuously maintaining the brake plates in motion and to prevent the yarn from sawing itself into the brake plates.

For setting the braking force, this printed publication further proposes to expose the brake plates, supported on a central pin, to the field of two external magnets, wherein one of the magnets is adjustably supported. The external magnets are oriented toward the respectively associated brake plates with equal poles, whereby repelling forces are generated. The brake plates center themselves in the middle between the two external permanent magnets. Compression springs may also be used instead of the external permanent magnets.

An adjustment of the braking force by adjusting the position of the adjustable permanent magnets or by adjusting a knurled screw which constitutes a counter support for one of the two springs holding together the two brake plates, adjusts the position of the brake plates. This is so, because the latter always seek to position themselves centrally between the two counter supports on which the springs are supported or centrally between the two external permanent magnets.

German publication DE-PS 29.30 641 discloses an electric yarn plate brake having a permanent magnet which generates a force that attracts the two brake plates to one another. The magnitude of the braking force can be regulated by the intensity of the current which excites the magnet. In this arrangement, however, the position of the braking plates is rigidly predetermined.

European publication EP 0 499 218 Al describes a yarn brake comprising two brake plates which are biased against one another and to which a radially directed oscillation is imparted by a cam device. The support of the brake plates is such that the position of the brake plates is firmly predetermined.

It has been found, however, that a fixed predetermination of the position of the brake plates may lead to difficulties in some applications.

It is therefore the object of the invention to provide a yarn brake which at least in part eliminates the disadvantages of the known yarn brakes.

### SUMMARY OF THE INVENTION

The present invention provides a yarn brake (1) which comprises individually adjustable biasing means (21, 22) which cooperate with brake plates (8, 9). By adjusting both biasing means (21, 22), desired positions of the brake plates (8, 9) may be deliberately set in a manner other than in conventional yarn brakes. For example, a desired centered position may be preserved for any yarn tension. It is also feasible to shift the desired centered position on purpose by deliberately adjusting both biasing means. The setting of the yarn tension is thus independent from the setting of the centered position.

The yarn brake according to the invention comprises two brake plates and a biasing means associated with each brake plate. The biasing means hold the brake plates or other brake elements in a centered position. When the brake plates are held in the centered position, the biasing means are each settable concerning their force exerted on the brake plates. If the biasing means are settable independently from one another, the centered position may be deliberately shifted from a given position into a changed position. In case the biasing means are of equal force, the centered position is the mid position between the two biasing means or counter supports on which the biasing means are supported. The centered position does not change if the biasing means are synchronously adjusted in mutually opposite directions. Rather, the centered position is resiliently set by the biasing means in one and the same position. The running yarn may allow the brake plates to oscillate about such a centered position, while an adjustment of the biasing force effects no change of such a centered position. This, for example, has advantages as concerns the yarn run. For example, the yarn brake may be of particularly compact construction. For example, a fixedly arranged knot catcher, through which the yarn runs before it reaches the brake plates, may be arranged very closely to the brake plates. Further, measuring devices sensing the yarn may be provided and integrated into the yarn brake. By means of the set mid position, the position of the running yarn does not change even in case the braking force is adjusted, whereby feedback effects on the measuring device are slight or may be excluded.

For adjusting the biasing means, counter supports, carrying the biasing means, such as compression springs, may be made adjustable. It is, however, also possible to use, for example, a magnet pair as the biasing means and further, magnets provided on the brake plates are associated with the magnet pair. In such a case the magnet pairs form the biasing means together with the magnetic field generated. For adjusting the obtained magnetic force, it is possible to adjust the position of the external magnets which otherwise are fixedly arranged during operation. The adjustment of the counter supports or the external magnets is effected in opposite directions and in synchronism. In this manner the centered position of the brake plates remains unchanged upon adjusting the yarn biasing force.

In case magnets are used as the biasing means for the brake plates, it is also possible to use permanent magnets as the magnets; in such a case an adjustment of the biasing force is effected by changing the position of the magnets. However, electromagnets may be used as the magnets, in which case the respective exciting currents are accordingly adjusted for changing the biasing force. In such a case too, the centered position of the brake plates remains unchanged when the exciting current is adjusted, provided the magnetic forces of the two magnet coils are changed synchronously, but in opposite sense. [0013] According to a preferred embodiment, the mechanical adjustment of the counter supports or the permanent magnets is effected by an adjusting device which imparts a synchronous adjustment to the counter supports or the permanent magnets in opposite directions. The adjusting device is preferably a gearing having a manipulator by means of which the adjustment is made. Such a gearing preferably has a non-constant transmission ratio to obtain, in case of small biasing forces, a greater adjusting stroke derived from an adjusting motion of the manipulator, and to obtain, in case of larger biasing forces, a comparatively smaller adjusting stroke. For such a purpose, the gearing has a non-constant transmission ratio; it may be a crank gearing, a screw gearing or the like. The embodiment structured as a crank gearing is particularly well adapted for a large-scale use because of its particular simplicity and its manufacture as simple, injection-molded components.

If required, the adjusting device may also be provided with one or two electric drives. For example, setting motors, piezo setting drives or the like may be utilized for adjusting the position of the counter supports or the external permanent magnets of the biasing means. In this manner a remote setting by suitable electrical signal conductors is feasible. These may be connected to the control of a yarn delivering apparatus or to the control of a yarn processing machine. It is further possible to provide the yarn brake with its own control unit which receives adjusting commands by means of a suitable data conductor and converts the commands independently by means of the adjusting device. In this connection it is feasible to provide the yarn brake with its own energy source which permanently or periodically supplies an extremely economical control device with energy, and makes available the energy for the setting motions expected during the service life of the yarn brake.

### BRIEF DESCRIPTION OF THE DRAWINGS

Further details of the advantageous embodiments of the invention are obvious from the drawings, from the related description or from the claims. The drawings illustrate exemplary embodiments in accordance with the invention, in which:

FIG. 1 is a perspective view of a yarn brake;

FIG. 2 a schematic view of a slightly modified embodiment of the yarn brake of FIG. 1;

FIG. 3 is a schematic side view of the yarn brake according to FIGS. 1 and 2;

FIG. 4 shows a modified embodiment of the yarn brake operating with a synchronized biasing force adjustment of both brake plates;

FIG. 5 shows an embodiment of an adjusting device of the yarn brake according to FIGS. 1, 2 and 4;

FIG. 6 and FIG. 7 are schematic views of a modified embodiment of an adjusting device illustrated in different setting positions;

FIG. 8 is a schematic view of a further modified embodiment of an adjusting device operating with an electromagnetic adjustment;

FIG. 9 is a schematic view of an electrically controllable adjusting device having two setting arrangements; and,

FIG. 10 is a schematic view of a further embodiment of an electrically adjustable adjusting device having an adjusting gearing.

### DESCRIPTION OF THE PREFERRED EMBODIMENTS

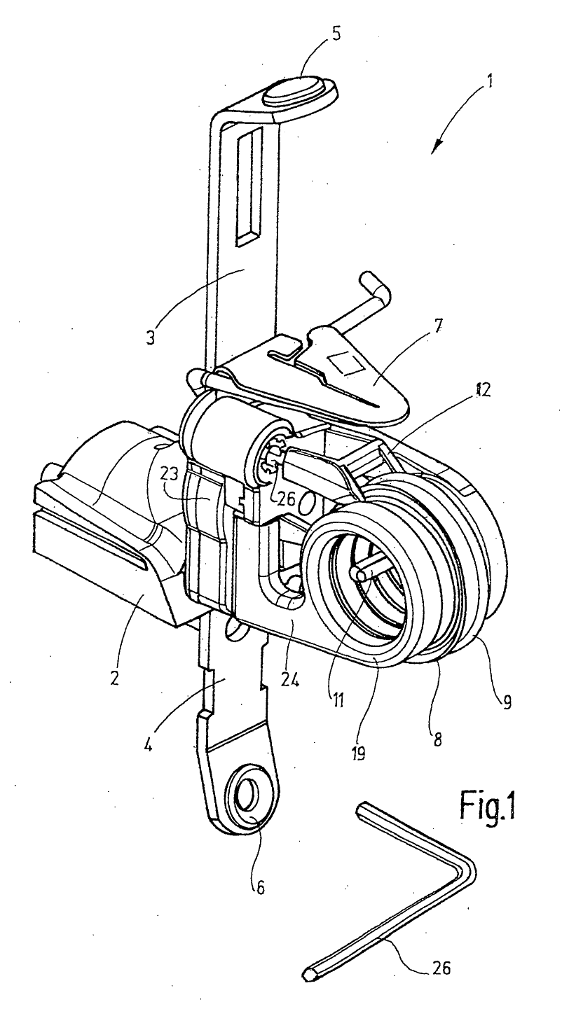

FIG. 1 illustrates a yarn brake 1 which may find application in positive feeders, storage feeders, bias-controlled feeders or also friction feeders. Additional uses are possible and are hereby not excluded. The yarn brake 1 comprises a carrier body 2 which may be affixed, for example, to the housing of a positive feeder. The carrier body 2 carries yarn eyelets 5, 6 mounted on suitable brackets 3, 4 and, if required, also carries a knot catcher 7, constituted, for example, by a slotted sheet metal component. For braking the yarn, between the knot catcher 7 and the outlet-side yarn eyelet 6 two, preferably annularly shaped, brake plates 8, 9 are arranged. A central yarn guiding pin 11 passes through the two brake plates 8, 9. As it may be seen particularly in FIG. 3, for supporting the brake plates 8, 9, guiding bodies 12, 13, 14 are provided, which straddle the brake plates 8, 9 at their outer periphery and guide them with a play. The guiding body 12 may also be seen in FIG. 1; it is, similarly to the guiding body 13, arranged in a stationary position. In contrast, the guiding body 14 and the yarn guiding pin 11 are preferably supported on a carrier 15, to which an oscillation may be imparted preferably radially to the yarn guiding pin 11 and the brake plates 8, 9.

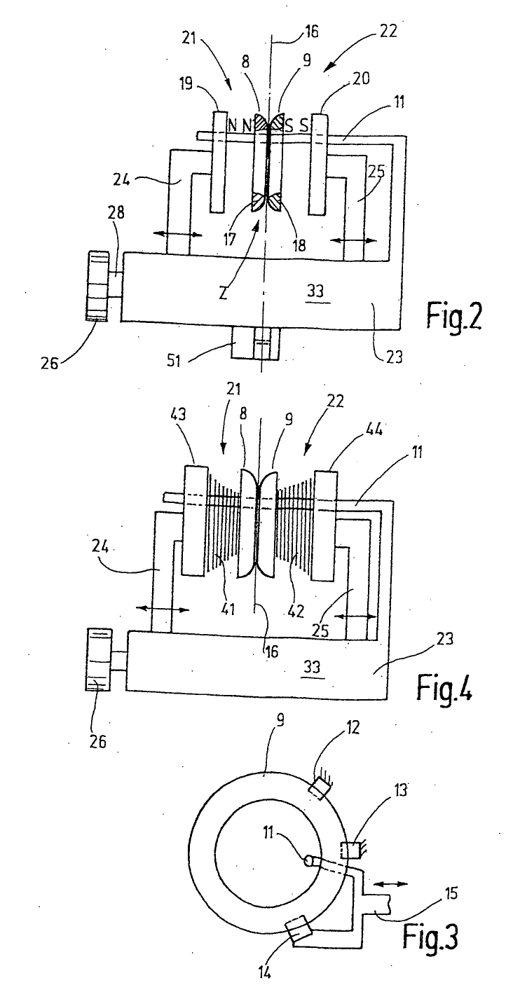

As particularly well seen in FIG. 2, for clamping a yarn 16, the brake plates 8, 9 are provided with preferably annular permanent magnets 17, 18. At their respective side oriented toward the yarn 16, the magnets 17, 18 have opposite poles, whereby they mutually attract one another.

The attraction force supplies a first force that clamps the yarn. A further additional force that clamps the yarn 16 is generated by external magnets 19, 20 which are preferably permanent magnets. The magnet 19 is associated with the brake plate 8, while the magnet 20 is associated with the brake plate 9. The magnets 19, 20 are oriented in such a manner that their poles face equal poles of the respective permanent magnets. Thereby repelling forces are obtained between the magnets 19, 20 and the permanent magnets 17, 18 held in a centered position between the magnets 19, 20. In this manner the permanent magnets 17, 18 and the externally arranged magnets 19, 20 constitute respective biasing means 21, 22, with which the braking force affecting the yarn 16 may be set. For this purpose, the magnets 19, 20 are supported such that they can be adjusted in synchronism and in opposite directions. For effecting an adjustment, an adjusting device 23 is provided which positions the two magnets 19, 20. The latter are supported or held on respective arms 24, 25, the position of which is adjustable by the adjusting device 23. An adjustment of the magnets 19, 20 by-the adjusting device 23 is effected by a manipulator 26, such as a lever, small wheel or a socket for accommodating a suitable tool.

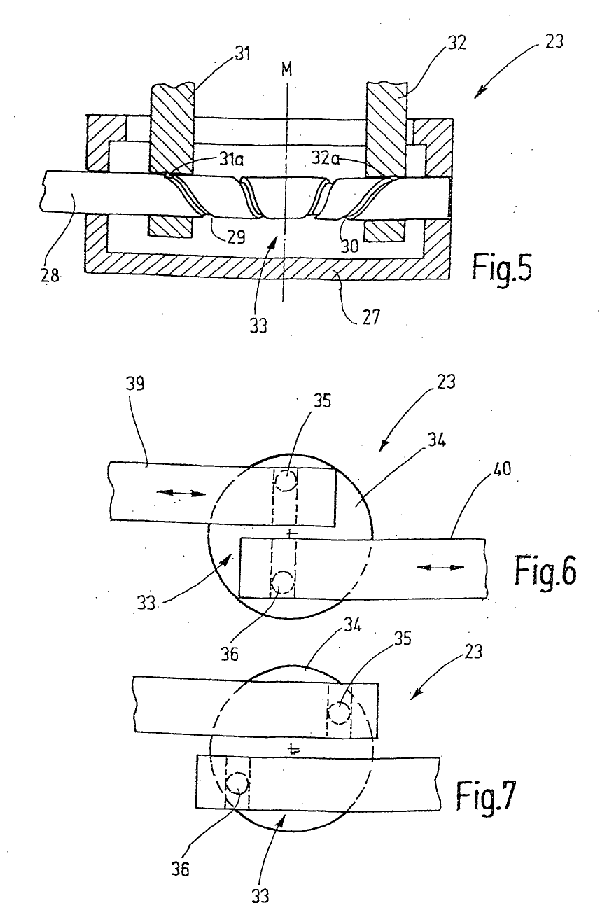

The adjusting device 23 may be structured, for example, as shown in FIG. 5. In a suitable housing 27 a shaft 28 is supported which is connected with the manipulator 26 (not shown in FIG. 5). The shaft 28 is provided with two axially spaced thread tracks 29, 30 which have oppositely oriented pitches. Further, the pitches may increase toward both ends of the shaft 28 from a center M indicated by a dash-dot line in FIG. 5.

Riders 31, 32 are mounted on the shaft 28 which extends through respective openings provided in the riders 31, 32. In each opening a respective projection 31a, 32a is provided in form of a lug which projects into the respective thread track 29 or 30. The riders 31, 32 are connected to, or constitute the arms 24, 25.

The yarn brake 1 described above operates as follows:

The yarn 16, as shown in FIG. 2, runs between the brake plates 8, 9 which are held against one another by the attracting force between the permanent magnets 17, 18. Further, the repelling forces between the permanent magnet 17 and the magnet 19 and between the permanent magnet 18 and the magnet 20 additionally press the brake plates 8 and 9 to one another. Further, the external repelling forces effect a centering of the two contacting brake plates 8, 9 in a centered position Z which is at mid distance between the external magnets 19, 20. During operation, the yarn guiding pin 11 and the guiding body 14 slightly vibrate, whereby the brake plates 8, 9 are always maintained in a slight motion.

In this manner the brake plates 8, 9 and also the running yarn 16 are essentially free from effects of static friction. The frictional forces derived from the yarn 16 further cause a preferably slow rotation of the brake plates 8, 9 about the yarn guiding pin 11. The brake plates 8, 9 should turn preferably slowly, so that they are worn uniformly by the running yarn. If the brake plates 8, 9 rotate too fast, the yarn 16 may jump out of the brake plates 8, 9. For this reason the driving torgue derived from the yarn 16 and applied to the brake plates 8, 9 is relatively small. Dependent on the path along which the yarn is guided through the brake plates, a greater or lesser forward or reverse rotating torque may be obtained.

By virtue of the magnetic bias on the brake plates 8, 9, particularly the bias effected by the external magnets 19, 20, the slow rotation of the brake plates 8, 9 meets only a very small resistance. Frictional effects derived from the bearings are reduced to a minimum. If, in contrast, one of the brake plates 8, 9 were urged against a fixed abutment or even a compression spring, frictional braking effects would be generated.

The solution according to the invention avoids such frictional effects. As a result, small driving torques leading to an only slow rotation of the brake plates 8, 9 are sufficient for the drive. This applies also when the brake plates 8, 9 are exposed to a more significant soiling, for example, by an accumulation of dust or yarn fragments. Therefore, operating with larger driving torques may be dispensed with; these would, to be sure, overcome the braking torques caused by soiling and bearing friction, but would lead, in case of clean brake plates, to an excessive rpm of the brake plates 8, 9. The rotation of the brake plates may be additionally supported by imparting a vibration to the yarn guiding pins and/or the guiding body. In the first place, as noted earlier, by means of the vibration, the brake plates 8, 9 are, to a large measure, freed from static friction effects. Second, the vibration may be so designed that it imparts a driving torque to the brake plates. It is, however, also possible to dispense with a vibrational excitation of the brake plates 8, 9 and to arrange the guiding body 14 as well as the yarn guiding pin 11 stationary, that is, at rest.

The manipulator 26 is rotated if the braking force applied by to yarn brake 1 is to be changed. The magnets 19, 20 are displaced toward one another for increasing the braking force, while for reducing the latter, the magnets 19, 20 are shifted away from one another. The non-linear gearing 33 of the adjusting device 23 illustrated in FIG. 5 provides for a fine adjustment in case of large yarn biasing forces, if the riders 31, 32 are close to one another. They are situated then in the region of small pitch. If, on the other hand, the riders 31, 32 are far away from one another, the magnets 19, 20 have only a slight additional contribution to the pressure of the brake plates 8, 9 against one another and thus to the braking of the yarn 16. In this instance the fineness of adjustment is less, because the thread tracks 29, 30 have a greater pitch in that region. In each case, however, independently from the adjusting position of the magnets 19, 20, the brake plates 8, 9 remain in the centered position Z.

FIGS. 6 and 7 show a modified, yet likewise advantageous, embodiment of the adjusting device 23 or more particularly, its gearing 33. In this embodiment the manipulator is connected to a rotary plate 34 which carries two pins 35, 36 offset at 180° to one another. The pins 35, 36 project into transverse grooves 37, 38 provided in respective sliding members 39, 40. The sliding members 39, 40, the rotary plate 34 and the pins 35, 36 thus constitute a crank drive. The sliding members 39, 40 are connected with the arms 24, 25 and displace them upon rotation of the rotary plate 34 toward or away from one another. In a close position of the magnets 19, 20 carried by the arms 24, 25 and thus by the sliding members 39, 40, a rotation of the rotary plate 34 causes only a slight adjustment of the magnets 19, 20. This condition is illustrated in FIG. 7. In contrast, in the distant position of the magnets 19, 20 from one another, a rotation of the rotary plate 34 effects a relatively large adjustment. Such a position of the adjusting device 23 is illustrated in FIG. 6. Thus, the gearing 33 shown in FIGS. 6, 7, similarly to the gearing 33 of FIG. 5, changes its transmission ratio as a function of the position of the shaft 28 or, respectively, the rotary plate 34. The gearing is thus non-linear.

An alternative embodiment, as shown in FIG. 4, utilizes, as the biasing means 21, 22, compression springs 41, 42 which are armed between the brake plates 8, 9 and outer counter supports 43, 44 carried by the arms 24, 25. In other respects the preceding description applies; the brake plates 8, 9 may or may not be provided with permanent magnets. In the latter case the force affecting the yarn 16 is applied exclusively by the compression springs 41, 42. A rotation of the manipulator 26 causes the counter supports 43, 44 to be adjusted synchronously in opposite directions. Non-linear spring characteristics of the compression springs 41, 42 may complement the non-linearity of the adjusting device 23. It is also feasible to work with a linear adjusting device 23, that is, with an adjusting device where a motion of the manipulator 26 is converted to a motion of the arms 24, 25 with a constant transmission ratio. The same also applies to the embodiment of FIG. 2.

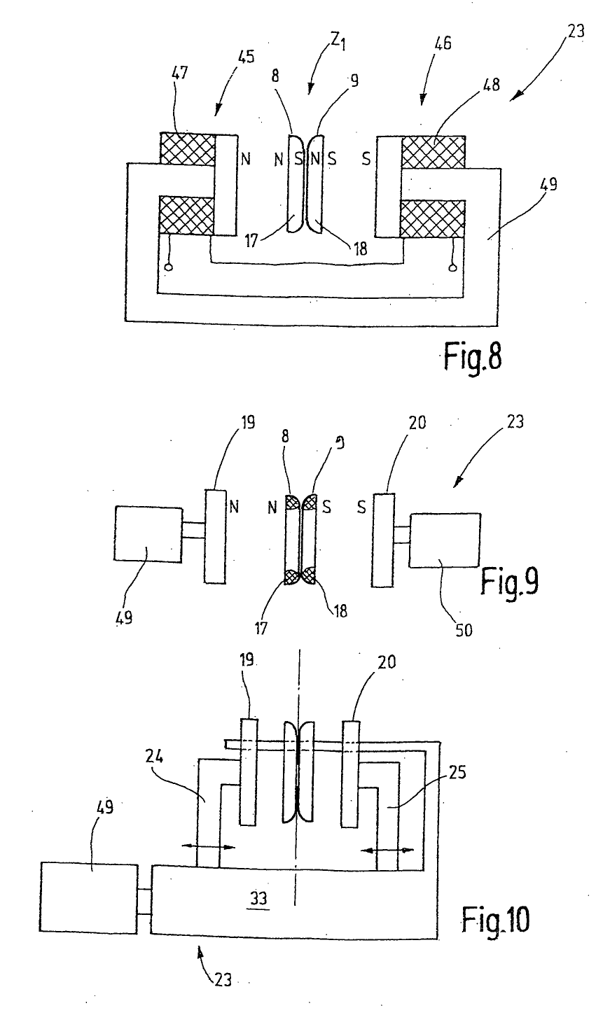

FIG. 8 illustrates a further embodiment of the invention in which the adjusting device 23 provides for a remote adjustment. For this purpose, the embodiment described in conjunction with FIG. 2 is modified by replacing the magnets 19, 20 with stationary mounted electromagnets 45, 46. The latter have respective magnet coils 47, 48 which, in case they have the same number of turns, are connected in series and in opposite sense. A magnetic circuit 49, forming an external yoke, may connect the electromagnets 45, 46 with one another. The magnet coils 47, 48 are of such a polarity that on their sides facing the permanent magnets 17, 18 they have poles equal to those of the permanent magnets 17, 18. By the intensity of the current flowing through the magnet coils 47, 48 the clamping force can be regulated with which the throughgoing yarn is held firmly and eventually braked by friction. The centered position Z is assumed by the effect of balancing forces as in all the previously described embodiments. The brake plates 8, 9 may vibrate or oscillate about such a centered position, while, however, the centered position Z is preserved in the middle, independently from the set braking force.

A further modified embodiment is illustrated in FIG. 9. In this embodiment the adjusting device 23 is composed of two electric setting devices 49, 50, such as electric setting motors, linear setting motors, piezo setting drives, linear piezo stepping motors or the like. The electric setting drives 49, 50 carry the magnets 19, 20 which, as otherwise shown in conjunction with FIG. 2, cooperate with the brake plates 8, 9, that is, with the permanent magnets 17, 18.

As shown in FIG. 10, it is, however, also possible to utilize but a sole setting drive 49 which may be connected with the magnets 19, 20 by a gearing 33. The setting drive 49 thus replaces the manipulator 26 of the embodiments according to FIGS. 2 or 4. The gearing 33, as described before, may be non-linear. It is, however, feasible to utilize a linear gearing having a constant step-up or step-down transmission ratio. Desired non-linear adjustment characteristics may be obtained electronically by a control device disposed ahead of the setting drive 49.

The yarn brake 1 according to the invention comprises individually adjustable biasing means 21, 22 which cooperate with brake plates 8, 9. By adjusting both biasing means 21, 22, desired positions of the brake plates 8, 9 may be deliberately set in a manner other than in conventional yarn brakes. For example, a desired centered position may be preserved for any yarn tension. It is also feasible to shift the desired centered position on purpose by deliberately adjusting both biasing means. The setting of the yarn tension is thus independent from the setting of the centered position.

The above makes it feasible to provide a measuring device 51 at or integrate the same in, the yarn brake 1. Such a measuring device which is, for example, schematically shown in FIG. 2, may be a tension measuring device, a yarn monitor, an optical measuring device or the like. In this connection, FIG. 2 shows schematically, in broken lines, a light beam which is traversed by the yarn 16. The measuring device may be, for example, designed for measuring the yarn tension and connected to a control device which, for example in the embodiment according to FIGS. 8, 9 or 10, automatically effects a follow-up adjustment of the yarn brake. If required, a signal input may be provided for adjusting a pre-given nominal value during operation.

What is claimed is:

1. A yarn brake comprising at least two mutually associated brake elements (8, 9) for clamping a yarn (16) between them and two biasing means (21, 22) associated with the brake elements (8, 9), the two biasing means (21,22) for pressing the brake elements (8, 9) toward one another with a biasing force while maintaining the brake elements (8,9) in a predetermined centered position, an adjusting device (23) associated with the two biasing means (21, 22), the adjusting device (23) for adjusting the two biasing means (21, 22) synchronously in opposite directions,
whereby the two biasing means (21, 22) are settable with respect to the magnitude of the generated biasing force which is applied to the brake elements (8, 9) situated in the centered position.

2. The yarn brake as defined in claim 1, further comprising individually adjustable counter supports (43, 44) associated with the two biasing means (21, 22).

3. The yarn brake as defined in claim 1, wherein the two biasing means (21, 22) each comprise a respective spring (41, 42).

4. The yarn brake as defined in claim 1, wherein the two biasing means (21,22) each comprise a respective magnet pair (17, 19; 18, 20).

5. The yarn brake as defined in claim 4, wherein the magnets (17, 19, 18, 20) of the magnet pairs (17, 19; 18, 20) have equal poles oriented facing one another.

6. The yarn brake as defined in claim 4, wherein at least one of the magnets (17, 19, 18, 20) of the magnet pairs (17, 19; 18, 20) has an annular configuration.

7. The yarn brake as defined in claim 2, wherein the counter supports (43, 44) are associated with adjusting device (23), the adjusting device (23) for adjusting the counter supports (43, 44) synchronously in opposite directions.

8. The yarn brake as defined in claim 1, wherein the adjusting device 23 further includes a gearing (33), a manipulator (26) connected to an input of the gearing (33).

9. The yarn brake as defined in claim 7, wherein the adjusting device 23 further includes a gearing (33), a manipulator (26) connected to an input of the gearing (33).

10. The yarn brake as defined in claim 1, wherein the adjusting device (23) further includes at least one electrically controlled adjusting drive (49, 50), a gearing (33) for connecting the at least one electrically controlled adjusting drive (49, 50) with at least one of the biasing means (21, 22) and the counter support (43, 44).

11. The yarn brake as defined in claim 2, wherein the adjusting device (23) further includes at least one electrically controlled adjusting drive (49, 50), a gearing (33) for connecting the at least one electrically controlled adjusting drive (49, 50) with at least one of the biasing means (21, 22) and the counter support (43, 44).

12. The yarn brake as defined in claim 8, wherein the gearing (33) has a non-constant transmission ratio.

13. The yarn brake as defined in claim 9, wherein the gearing (33) has a non-constant transmission ratio.

14. The yarn brake as defined in claim 10, wherein the gearing (33) has a non-constant transmission ratio.

15. The yarn brake as defined in claim 11, wherein the gearing (33) has a non-constant transmission ratio.

16. The yarn brake as defined in claim 12, wherein the gearing (33) has a screw gearing.

17. The yarn brake as defined in claim 13, wherein the gearing (33) has a screw gearing.

18. The yarn brake as defined in claim 14, wherein the gearing (33) has a screw gearing.

19. The yarn brake as defined in claim 15, wherein the gearing (33) has a screw gearing.

20. The yarn brake as defined in claim 1, further including a gearing (33), the gearing (33) has a crank gearing.

21. The yarn brake as defined in claim 1, further including a gearing (33) associated with the biasing means.(21, 22), the gearing (33) having a larger transmission ratio in a first region and the gearing (33) having a smaller transmission ratio in a second region, whereby in the first region the biasing means (21, 22) generates a smaller force and in the second region the biasing means (21, 22) generates a larger force.

22. The yarn brake as defined in claim 1, wherein the yarn brake (1) further includes at least one measuring device (51).
